(19) United States
(12) Patent Application Publication
(10) Pub. No.: US 2017/0009733 A1
(43) Pub. Date: Jan. 12, 2017

(54) WAVE ENERGY PLANT HAVING OFFSET FLOATS

(71) Applicant: WAVES RUIZ, Octeville Sur Mer (FR)

(72) Inventor: Jose Antonio RUIZ DIEZ, Octeville Sur Mer (FR)

(73) Assignee: WAVES RUIZ, Octeville Sur Mer (FR)

(21) Appl. No.: 15/121,911

(22) PCT Filed: Feb. 26, 2015
(86) PCT No.: PCT/FR2015/050461

§ 371 Date: Aug. 26, 2016

(30) Foreign Application Priority Data
Feb. 26, 2014 (FR) 14 51557

(51) Int. Cl. F03B 13/20

(52) U.S. Cl. CPC F03B 13/20; F05B 2260/4031

(57) ABSTRACT

A wave energy plant that includes a semi-submersible platform provided with at least one longitudinal casing that extends from a bow to a stern of the platform and a wave energy machine mounted on the platform. The machine includes a gantry transversely mounted on the casing on the bow of the platform, floats are arranged so as to enable the wave energy to be converted into mechanical energy, i.e. at least one primary float and at least one secondary float, longitudinally offset relative to the primary float and a transformer. The platform includes at least one stabilizer aileron extending transversely within the lower edges of the casings of the platform.

The invention relates to the field of energy production and, more specifically, to the field of the production of electrical energy from wave energy.

The invention relates to a wave energy plant equipped with a platform and with a wave energy machine mounted on this platform and equipped with floats of which the upward or downward movement according to the waves (which also exert a horizontal thrust on the floats) is converted into hydraulic energy, this hydraulic energy being in turn converted into electrical energy by means of a converter: a mechanical system, hydraulic motor associated with a generator, or even a hydroelectric turbine.

More specifically, a wave energy plant comprising:
a semisubmersible platform provided with at least one longitudinal casing which extends from a bow to a stern of the platform;
a wave energy machine mounted on the platform, this machine comprising:
   a gantry mounted transversely on the casing at the bow of the platform,
   floats arranged in such a way as to allow the wave energy to be converted into mechanical energy, each float comprising a bow facing towards the bow of the platform and a stern facing towards the stern of the platform, each float being mounted with the ability to rotate with respect to the gantry on a shaft secured thereto, situated on the side of the bow of the float,
   a converter
is known from French patent application FR 2 992 626 or its international equivalent WO 2014/001717.

Such a plant has fairly large dimensions. Its length is generally of the order of 100 m, and its width of the order of 25 m. Because of its design, and particularly because of the dimensions of the platform, the plant is very stable in the waves, making it possible to maximize the amplitude of the movements of the floats and therefore optimize the recovery of energy.

In the wave energy plant described in the abovementioned document, the floats are mounted in pairs between two gantries, on two separate shafts, the floats of the two pairs being driven in oscillatory movements in opposite (contrarotating) directions. These contrarotating movements make it possible to stabilize the platform against listing and limit (or even cancel out) turning moment effects.

However, this design does require the creation of two gantries each one housing a technical area. This results in the plant becoming heavier and relatively painstaking maintenance being required that involves interventions in each technical area. The solution of mounting the floats on a single shaft would lighten the structure and simplify maintenance but lead to a reduction in the output of the platform because of the turning moment effects generated on the shaft. These turning moment effects in fact cause the platform to oscillate of its own accord and reduce the amplitude of the movements of the floats.

One objective is to propose a wave energy plant that offers at least one (and preferably all) of the following advantages: good energy output, relative ease of maintenance, good platform stability, particularly against listing.

To this end there is proposed a wave energy plant which comprises:
a semisubmersible platform provided with at least one longitudinal casing which extends from a bow to a stern of the platform;
a wave energy machine mounted on the platform, this machine comprising:
   a gantry mounted transversely on the casing at the bow of the platform,
   at least one primary float and at least one secondary float arranged in such a way as to allow the wave energy to be converted into mechanical energy, each float comprising a bow facing towards the bow of the platform and a stern facing towards the stern of the platform, the floats being mounted with the ability to rotate with respect to the gantry on a shaft secured thereto, the secondary float being offset from the primary float towards the bow of the platform,
   a converter.

Various additional features may be provided, alone or in combination:
the primary float is mounted with the ability to rotate with respect to the gantry on a primary shaft secured thereto, and the secondary float is mounted with the ability to rotate with respect to the gantry on a secondary shaft secured thereto and offset longitudinally with respect to the primary shaft towards the bow of the platform;
the platform comprises at least two longitudinal casings delimiting a central lane in which at least one primary float is positioned, the gantry is mounted transversely between the casings and at least one secondary float is mounted outside the central lane;
the wave energy machine comprises at least two secondary floats positioned one on each side of the central lane;
the platform, at its bow, comprises a stabilizing fin which extends transversely short of a lower edge of the casing;
the platform at its stern comprises a transverse buoyancy beam secured to the casing;
each float comprises a bottom and side walls, is mounted with the ability to rotate with respect to the gantry about a position of equilibrium corresponding to a water line of the float, and the float is provided with a pair of fins which project from the side walls near its stern, each fin having an intrados that is inclined, with respect to the water line, downwards towards its stern;
the converter comprises at least one ratchet wheel;
the converter comprises a main gearwheel secured to the shaft in direct mesh with the ratchet wheel;
the converter comprises a secondary gearwheel secured to the shaft in mesh with a ratchet wheel via a reversing pinion;
the converter comprises at least one flywheel;
the wave energy machine comprises at least one additional float, mounted with the ability to rotate with respect to the gantry on the shaft, on the side of the stern of the additional float.

Other objects and advantages of the invention will become apparent in the light of the description of one embodiment which is given hereinafter with reference to the attached drawings in which:

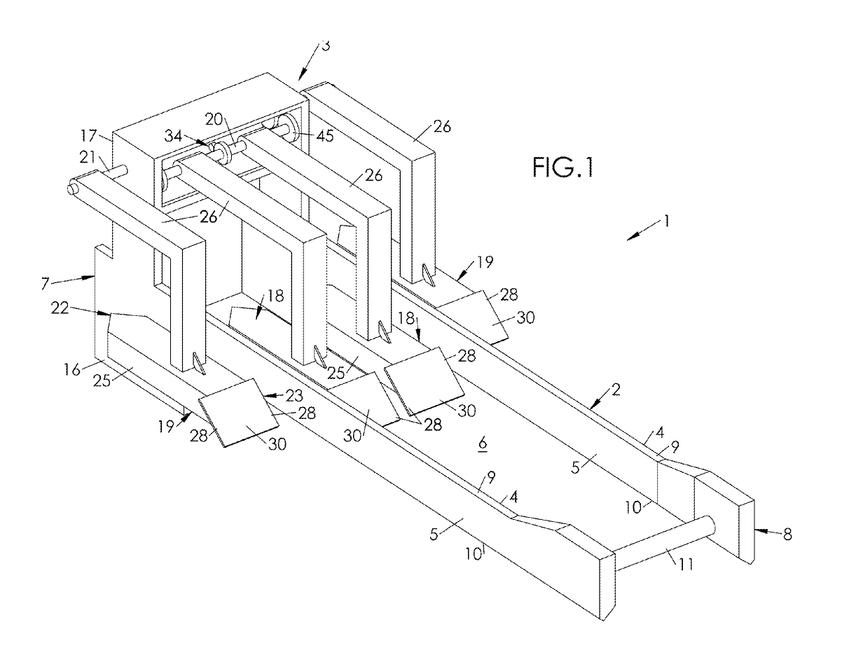

FIG. 1 is a perspective view of a wave energy plant;

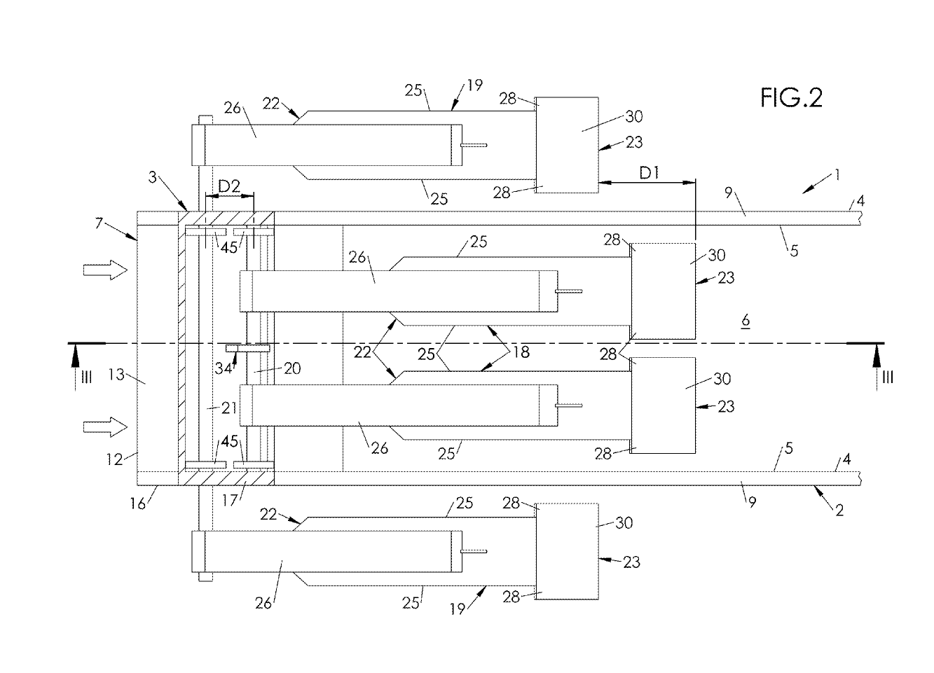

FIG. 2 is a partial view of the plant of FIG. 1, from above;

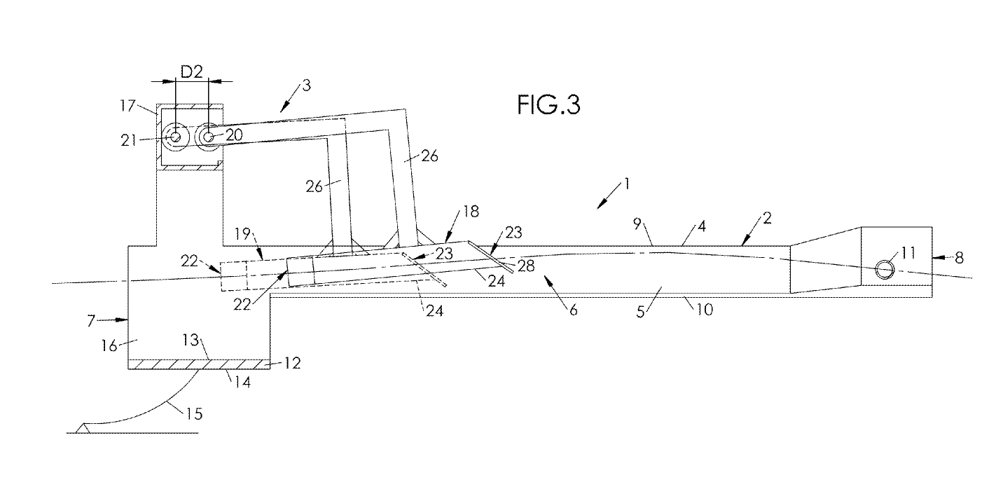

FIG. 3 is a view in cross section on the plane of section III-III of the plant of FIG. 2;

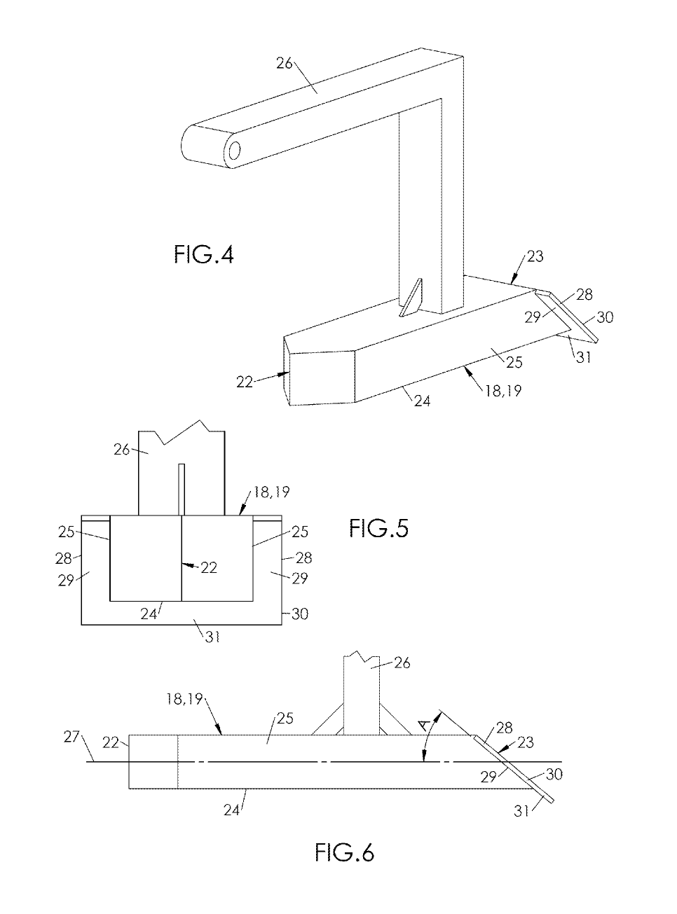

FIG. 4 is a perspective view of a float with which the plant is equipped, according to a first embodiment;

FIG. 5 is a partial side view of the float of FIG. 4;

FIG. 6 is a partial face-on view of the float of FIGS. 4 and 5;

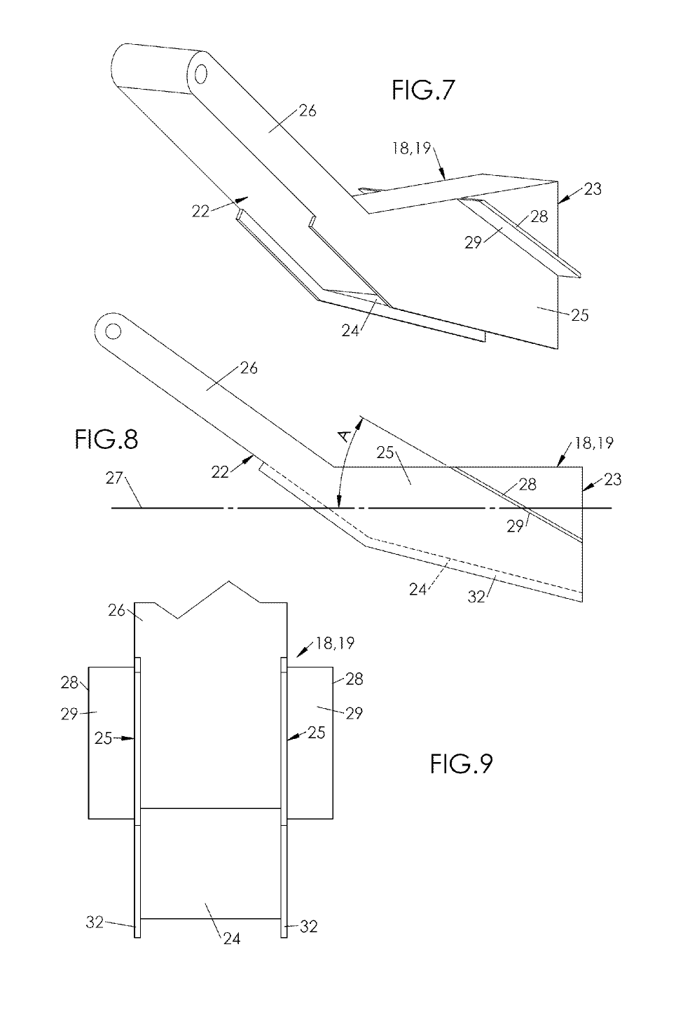

FIG. 7 is a perspective view of a float with which the plant is equipped, according to a second embodiment;

FIG. 8 is a side view of the float of FIG. 7;

FIG. 9 is a partial face-on view of the float of FIGS. 7 and 8;

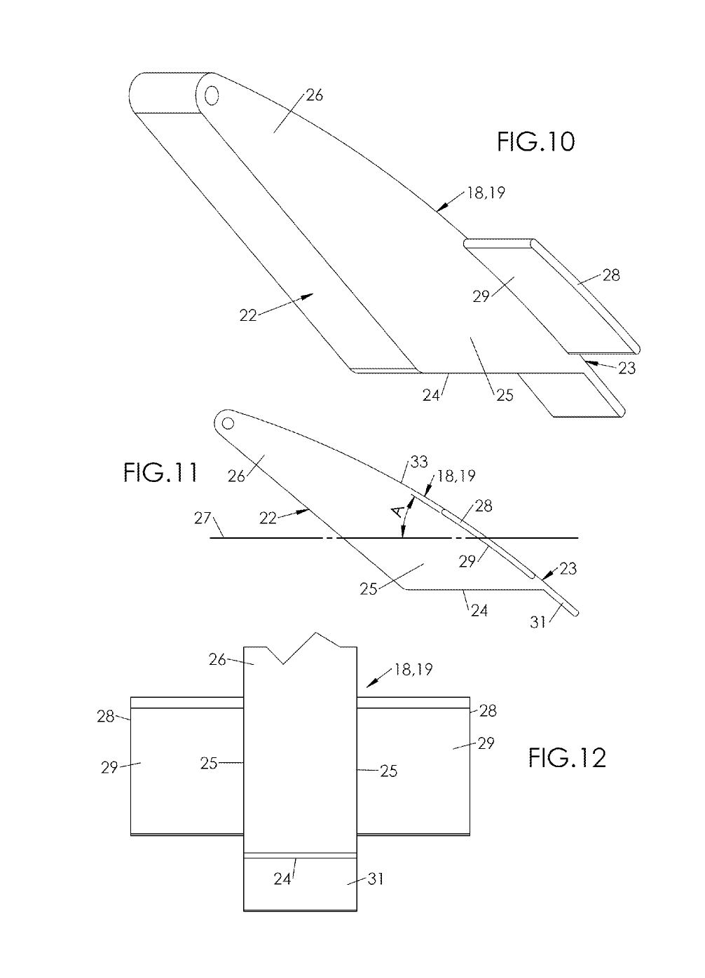

FIG. 10 is a perspective view of a float with which the plant is equipped, according to a third embodiment;

FIG. 11 is a side view of the float of FIG. 10;

FIG. 12 is a partial face-on view of the float of FIGS. 10 and 11;

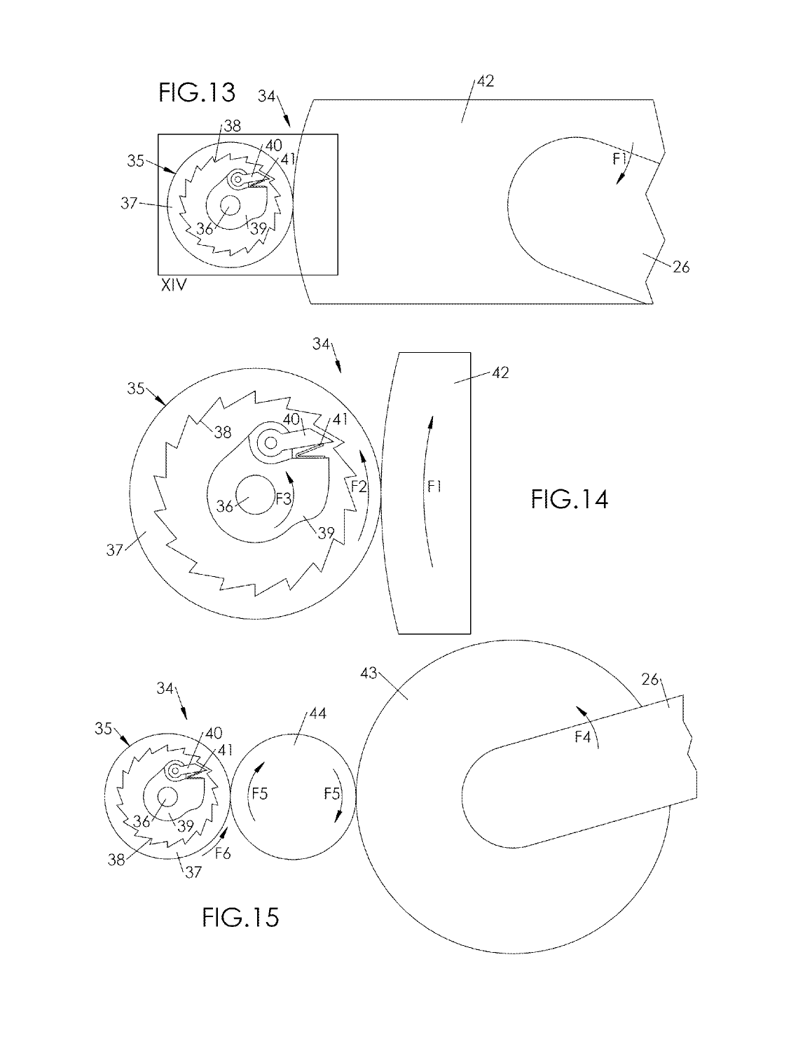

FIG. 13 is a schematic partial view showing an energy converter with which the plant is equipped, including a ratchet wheel and a gearwheel in direct mesh with the ratchet wheel;

FIG. 14 is a detailed view of the energy converter of FIG. 13, showing the boxed feature XIV;

FIG. 15 is a view similar to FIG. 13, showing an energy converter including a ratchet wheel and a gearwheel in indirect mesh with the ratchet wheel via a reversing pinion;

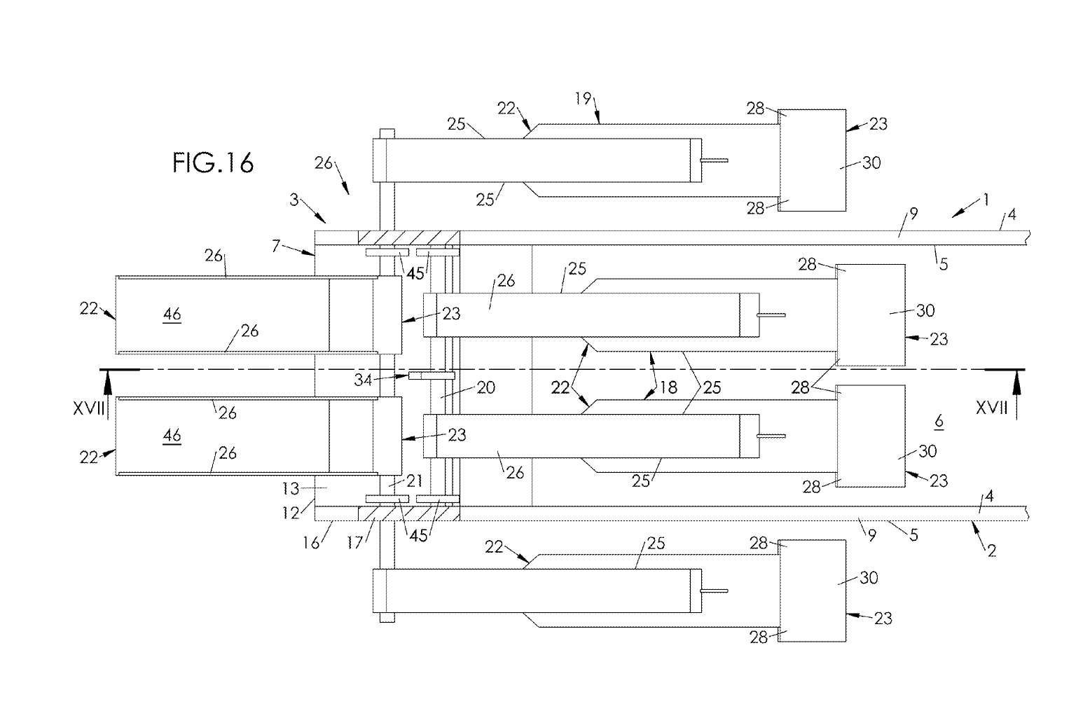

FIG. 16 is a view similar to FIG. 2, showing a plant according to an alternative form of embodiment;

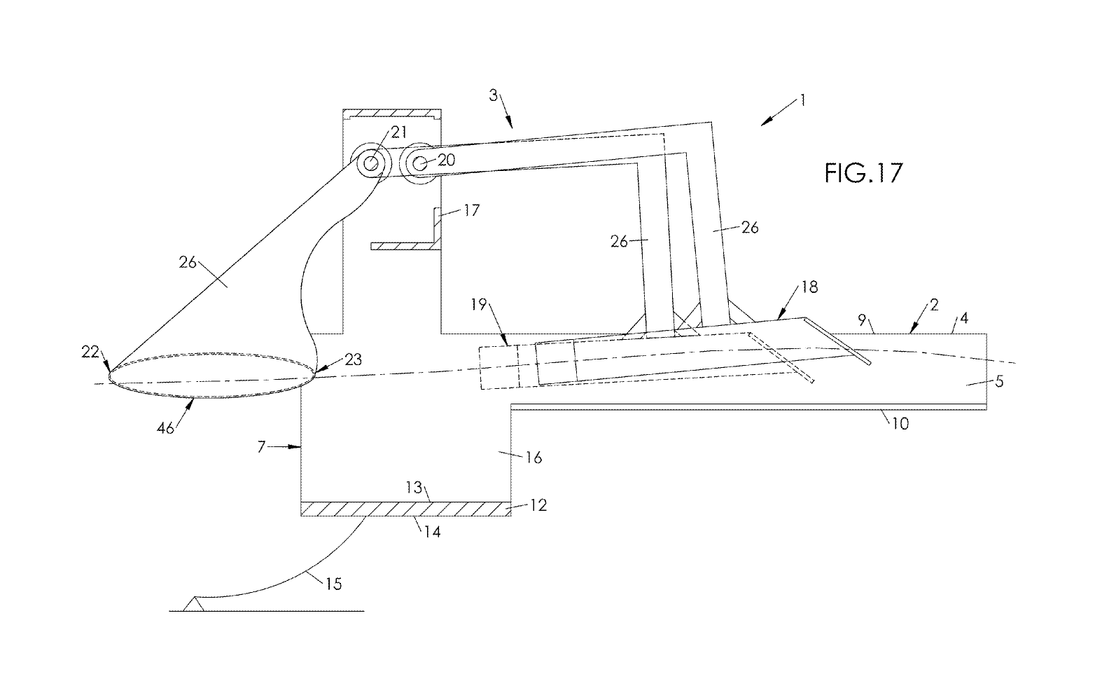

FIG. 17 is a view in section on the plane of section XVII-XVII of the plant of FIG. 16;

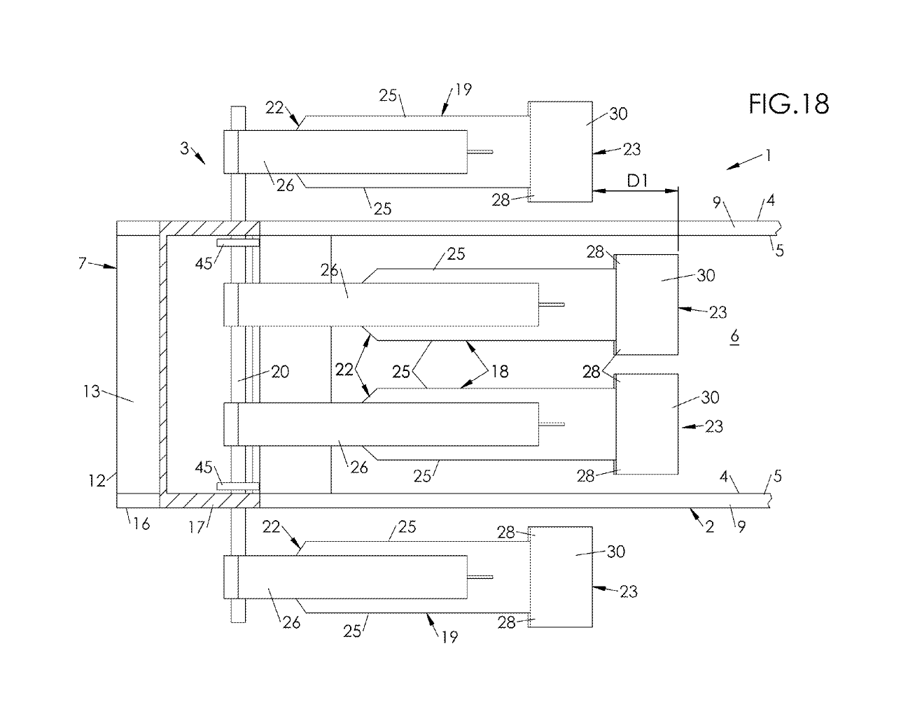

FIG. 18 is a view similar to FIGS. 2 and 16, showing a plant according to another alternative form of embodiment.

FIG. 1 depicts a wave energy plant 1. This plant 1, intended to be installed offshore, comprises a semisubmersible platform 2 and a wave energy machine 3 mounted on the platform 2.

The semisubmersible platform 2 is equipped with at least one elongate buoyancy casing 4. In the example illustrated, the platform 2 is equipped with several elongate buoyancy casings 4, running substantially parallel to one another in a longitudinal direction which, when the plant 1 is at sea, corresponds to the main direction of travel of the waves (depicted by arrows situated to the left in FIG. 2).

In the example illustrated, the casings 4 are two in number and have a parallelepipedal shape and rectangular section, with a height preferably greater than their width. The casings 4 have solid or perforated side walls 5 which jointly delimit a central lane 6 which extends from a bow 7 (to the left in FIGS. 1, 2 and 3) to a stern 8 (to the right in FIGS. 1, 2 and 3) of the platform 2.

Thanks to the side walls 5 of the casings 4, the seawater is channeled along the lane 6 in the main direction of travel of the wave, thereby limiting rolling (or listing) movements of the platform 2. Each casing 4 has a longitudinal upper edge 9 and a longitudinal lower edge 10 which are opposite one another and which, in a calm-to-moderate (although still wavy) sea, are respectively emerged and immersed.

Each casing 4 is preferably hollow and produced by assembling metal plates (for example made of steel treated against corrosion), composite sheets or sheets made of any other material that is rigid enough and able to withstand bending loadings and corrosion. Each casing 4 may be stiffened using interior ribs, in order better to withstand the bending stresses both in the longitudinal plane (notably when the casing is cantilevered across the crest of a wave or when it is supported at its two ends by two successive crests), and in its transverse plane (notably in the event of local vortex).

Each casing 4 may further be compartmentalized to form ballast tanks which may be at least partially filled with seawater or emptied out in order to adjust the water line. The filling and emptying of the ballast tanks can be performed using pumps, preferably operated automatically. This adjustment is preferably performed so that the water line lies more or less along the middles of the casings 4—in other words, so that the draft and freeboard of the casings 4 are substantially identical.

According to one embodiment illustrated in FIGS. 1 and 3, each casing 4 has, at the stern 8, a widened and/or raised end (as is particularly visible in FIG. 3). As a result, the volume of air trapped in the casings 4 there is higher, and the buoyancy of the platform 2 is locally increased at its stern 8.

As may be seen in FIGS. 1, 2 and 3, the platform 2 comprises, at its stern 8, a buoyancy beam 11 secured to the casings 4 and which extends transversely, connecting them. Aside from its function of coupling and spacing the casings 4, and of stiffening the platform 2, the beam 11 acts as a float in order constantly to keep the stern 8 at sea level. In other words, as can be clearly seen in FIG. 3, the stern 8 accompanies the wave (depicted in chain line in this figure).

The beam 11 may, in longitudinal section (FIG. 3) have any shape but it is preferable, in order to optimize its float function, for it to have a circular shape. Thus, in the example illustrated, the beam 11 is itself hollow and tubular, of circular cross section. The vertical positioning of the beam 11 is tailored to suit the design of the platform 2 and, in particular, the shape of the casings 4; in the example illustrated, the beam 11 extends approximately mid-way up the casings 4.

The platform 2 further comprises at least one stabilizing fin 12 which, at sea, is normally constantly submerged, this fin 12 extending transversely short of the lower edges 10 of the casings 4, at the bow 7 of the platform 2.

The bow fin 12 extends over just part of the length of the platform 2 (typically between ⅕ and 1/10 of this length).

The fin 12 has an upper face 13 or extrados that is substantially flat, parallel to and facing the lower longitudinal edges 10 of the casings 4, and a lower face or intrados 14, by means of which the platform 2 can be anchored to the sea bed by means of a catenary 15 secured to the platform 2. Anchoring the catenary 15 to the fin 12 means that the platform 2 can automatically be oriented to face into the waves, the forces being applied along the axis thereof, thereby keeping the catenary 15 constantly taut.

The fin 12 has, in cross section, the shape of a U and comprises two lateral sides 16 which extend from the lower edges 10 of the casings 4, in the vertical continuation thereof, so that the extrados 13 extends some distance from the lower edges 10 of the casings 4 so that the fin 12, situated at a lower level than the casings 4, is always submerged at sufficient depth to be sheltered from the effects of the waves.

The result of this is that the platform 2 sits at a stable trim attitude because of the weight of the column of water surmounting the fin 12, and which acts as a damper, damping the movements of the platform 2, notably rolling (or listing) movements. The combined effects of the damping function of the fin 12 and of the platform 2 being anchored by the catenary 15 mean that the bow 7 of the platform 2 is somewhat insensitive to waves and maintains a substantially constant trim attitude.

By contrast, the stern 8 follows the waves because of the buoyancy of the stern ends of the casings 4 which buoyancy is combined with that of the beam 11. Thus, the waves cause the platform 2 to oscillate at the stern 8, this being centered on an axis that more or less coincides with a transverse midline of the fin 12. The wave energy machine 3 is mounted on the platform 2 at its bow 7. The machine 3 comprises, first of all, a gantry 17 mounted on the casings 4 so that it extends transversely between them in vertical alignment with the fin 12, and which couples them at their upper edges 9.

The wave energy machine 3 secondly comprises floats 18, 19 with the ability to rotate with respect to the platform 2, these being designed to allow the wave energy to be converted into mechanical energy, namely:
at least one primary float 18 mounted with the ability to rotate with respect to the gantry 17 on a primary shaft 20 secured to the gantry 17,
at least one secondary float 19 mounted with the ability to rotate with respect to the gantry 17 on a secondary shaft 21, likewise secured to the gantry.

Each float 18, 19 comprises a bow 22 facing towards the bow 7 of the platform 2, and a stern 23 facing towards the stern 8 of the platform 2.

The primary shaft 20 is situated on the same side of the bow 22 (namely at the upstream end) of the primary float 18. Likewise, the secondary shaft 21 is situated at the same side as the bow 22 (which means to say at the upstream end) of the secondary float 19. In this way the floats 18, 19 are, during operation, driven in oscillatory rotary movements in the same direction of rotation.

However, as can be seen clearly in FIGS. 2 and 3, the secondary float 19 is offset longitudinally with respect to the primary float 18 towards the bow 7 of the platform 2. The offset, measured longitudinally, between the floats 18, 19 is denoted D1. This offset D1 may be measured between the bows 22 of the floats 18, 19, between their sterns 23, or alternatively between their respective centers of gravity.

According to one particular embodiment, illustrated notably in FIGS. 1 to 3, the secondary shaft 21 is offset longitudinally with respect to the primary shaft 20. The offset, measured longitudinally, between the shafts 20, 21 is denoted D2.

The offsets D1 and D2 may be identical, notably when the floats 18, 19 are identical. However, the offsets D1 and D2 may be different. According to one embodiment, the offsets D1 and D2 are comprised between 5 m and 20 m.

As illustrated in the figures, the wave energy machine 3 comprises at least one primary float 18 positioned in the lane 6, and at least one secondary float 19 mounted outside the lane 6. As can be seen clearly in FIGS. 1 and 2, the secondary shaft 21 extends transversely projecting from the lateral wall 5 to allow the articulated mounting of the secondary float 19.

In the example illustrated, the wave energy machine 3 comprises at least two secondary floats 19, positioned one on each side of the lane 6. Each secondary float 19 is thus mounted in an articulated manner on a projecting portion of the secondary shaft 21.

As is also visible, in the example illustrated, the wave energy machine 3 comprises two primary floats 18 arranged inside the lane 6. As an alternative, the number of floats 18 or 19 could be higher.

The longitudinal offset of the secondary float(s) 19 with respect to the primary floats 18 makes it possible to minimize the list adopted by the platform 2 and therefore to stabilize same. Specifically, as illustrated in FIG. 3, in which a secondary float 19 is depicted in dotted line, as hidden detail visible through the casing 4, the oscillations of the primary float(s) 18 and of the secondary float(s) 19 are not synchronous, each crest reaching the secondary float(s) 19 first of all. Such asynchronism makes it possible to distribute the turning moment effect generated by the floats 18, 19 and therefore at each moment reduce the bending forces applied to the platform 2 (and more specifically to the casings 4). That makes it possible to minimize the working section of the casings 4 and therefore make the platform 2 lighter.

The primary floats 18 and the secondary floats 19 may be similar or identical (as in the example illustrated) or may be different.

Each float 18, 19 comprises a bottom 24 and side walls 25 which extend both vertically from the bottom 24 and longitudinally from the bow 22 to the stern 23.

Each float 18 (or 19) is secured to a rigid arm 26 mounted with the ability to rotate on the primary shaft 20 (or the secondary shaft 21) and which extends towards the stern 8 from the shaft 20, 21.

Each float 18, 19 is mounted with the ability to rotate in an oscillatory manner on its shaft 20, 21 about a position of equilibrium (in the absence of waves) which corresponds to a water line 27 of the float 18, 19 (depicted in chain line in FIGS. 5, 8 and 11).

Each float 18, 19 is preferably provided with a pair of fins 28 which project from the side walls 25 in the vicinity of the stern 23. Each fin 28 has an intrados portion 29 that is inclined, with respect to the water line 26, downwards towards the stern 23 of the float 18, 19. The angle of inclination between the intrados 29 of the fin 28 and the water line 27 on is denoted A. This angle A is preferably comprised between 10° and 45°.

The fins 28 increase the lift force applied by the waves to the float 18, 19 and make it possible to recover energy from the horizontal forces applied to the floats 18, 19 in the case of waves of low or medium amplitude, thereby improving the energy efficiency of the plant. In the event of high waves, the fins 28 will on the crest adopt a substantially horizontal orientation, thus canceling out the lift (and therefore the loadings generated on the shaft 20, 21), to the benefit of the safety of the plant 1. As the inclination of the float 18, 19 varies according to the waves, it will be appreciated that the lift generated on the fins 28 is not constant. In practice, the stronger the waves, the less useful the fins 28 prove to be as the fins 28 rather offer maximum action in the event of light to moderate waves.

There are a number of conceivable embodiments for each float 18, 19.

According to a first embodiment, illustrated in FIGS. 4 to 6, the fin 28 is formed of an inclined plate 30 mounted to the stern 23, and which protrudes transversely beyond the side walls 25 on each side. As is clearly visible in FIG. 6, the bottom 24 is substantially flat and parallel to the water line 27, as far as the plate 30 which forms an inclined deflector 31 extending in the continuation of the fins 28.

According to a second embodiment illustrated in FIGS. 7 to 9, the arm 26 extends from the bow 22 of the float 18, 19; the bottom 24 is inclined with respect to the water line 27, from the vicinity of the arm 26 as far as the stern 8. As can be seen in FIGS. 7 to 9, the float 18, 19 comprises two lips 32 which extend longitudinally, projecting from the bottom 24 on each side of the continuation of the side walls 25. These lips 32 serve to partially channel the water which flows under the float 18, 19. The result of this is that it minimizes the risk of turbulence in the flow at the bottom 24 and at the fins 28 and therefore that it improves the efficiency of the float 18, 19.

According to a third embodiment illustrated in FIGS. 10 to 12, the float 18, 19 is more profiled than in the second embodiment. The fins 28 extend in the continuation of an upper face 33 (which may be slightly curved) of the float 18, 19, which is the opposite face to the bottom 24. As may be seen in FIG. 11, the intrados 29 may be concave (with the concavity facing towards the bow of the float 18, 19). Furthermore, the float 18, 19 may comprise a deflector 31 which extends at the stern 23 in the continuation of the upper face 33 and at an incline with respect to the water line 27, whereas the bottom 24 is substantially flat and parallel to this line.

The gantry 17 is preferably dimensioned generously enough to form a technical area accommodating and housing the equipment of the plant 1, notably for converting mechanical wave energy into electrical energy.

The machine 3 for that purpose thirdly comprises, for each shaft 20, 21, at least one converter 34 allowing the oscillatory movements of the floats 18, 19 to be converted into a continuous rotational movement, the latter being able to be used via a generator (not depicted) to produce electricity. This converter 34 comprises, for each shaft 20, 21, a pair of ratchet wheels 35 mounted on a driveshaft 36 parallel to the shaft 20, 21.

According to an embodiment illustrated in the figures, each wheel 35 comprises an annulus gear 37 with a one-way internal toothset 38 and a two-way external toothset (which has not been depicted). The wheel 35 comprises a driven wheel 39 secured to the driveshaft 36 and on which is mounted with the ability to rotate a pawl 40 in one-way mesh with the toothset 38. The pawl 40 is urged towards the toothset 38 by a spring 41.

The converter 34 moreover comprises, for each shaft 20, 21, a main gearwheel 42 which rotates as one with the shaft 20, 21 and is in direct mesh with a first ratchet wheel 35, and more specifically with the external toothset of the annulus gear 37, as illustrated in FIGS. 13 and 14.

The converter 34 further comprises, for each shaft 20, 21, a secondary gearwheel 43 which rotates as one with the shaft 20, 21 and is in mesh with the second ratchet wheel 35 (and, more specifically, with the external toothset of the annulus gear 37) via a reversing pinion 44.

In that way, the float 18, 19, via the arm 26, drives, together with the shaft 20, 21, the main gearwheel 42 in a first direction of rotation (the clockwise direction in the figures, cf. arrow F1 in FIGS. 13 and 14) the latter driving the annulus gear 37 of the first ratchet wheel 35 in the opposite direction (counterclockwise, arrow F2 in FIG. 14). The pawl 40, in mesh with the internal toothset 38, then drives the driven wheel 39 (and therefore the driveshaft 36) in the same direction as the annulus gear 37 (the counterclockwise direction, arrow F3, FIG. 14).

At the same time, the secondary gearwheel 43 via the reversing pinion 44 drives the annulus gear 37 of the second ratchet wheel 35 in the clockwise direction, the annulus gear 37 then rotating freely about the driveshaft 36.

Conversely, when the float 18, 19, via the arm 26, with the shaft 20, 21 drives the main gearwheel 42 in the counterclockwise direction, this drives the annulus gear 37 of the first ratchet wheel 35 in the clockwise direction, the annulus gear 37 then rotating freely about the driveshaft 36.

At the same time, the secondary gearwheel 43 drives (in the counterclockwise direction in the figures, cf. arrow F4 in FIG. 15) the annulus gear 37 of the second ratchet wheel 35 in the counterclockwise direction (arrow F6) via the reversing pinion 44 (clockwise direction, arrow F5). The pawl 40, in mesh with the internal toothset 38, then drives the driven wheel 39 (and therefore the driveshaft 36) in the same (counterclockwise) direction as the toothset.

Because of the design described hereinabove, whatever the direction in which the arm 26 rotates, one or other of the gearwheels 42, 43 drives the driveshaft 36 via one or other of the ratchet wheels 35. In other words, the energy conversion is continuous, whether the float 18, 19 is moving up or down.

It will be noted that the converter 34 may include one (or several) flywheel(s) 45 mounted, for example, on each shaft 20, 21 (or on the driveshaft 36), so as to smooth jerkiness and thus regulate the rotational speed of the driveshaft 36 (and therefore the operating speed of the plant 1). This results in a smoothing of the production of electrical current.

The design of the plant 1 affords a number of advantages.

First of all, as we have seen, the longitudinal offsetting of the secondary floats 19 with respect to the primary floats 18 makes it possible to limit the listing of the platform 2 and therefore stabilize it, to the benefit of the energy output of the plant 1.

Secondly, the fact that there is only the one gantry 17 makes maintaining the plant 1 easier, it being possible for all of the maintenance operations to be performed from this one single technical area.

It should be noted that it is conceivable to couple several plants 1 together either by aligning them in a row across one and the same line of waves, or by offsetting them longitudinally (i.e. in the direction of travel of the waves).

There are a number of alternative forms of embodiment that may be foreseen.

According to an alternative form of embodiment illustrated in FIGS. 16 and 17, the plant comprises one (or more) additional float(s) 46 arranged upstream of the gantry 17 and mounted on the secondary shaft 21. Like the floats 18 and 19, each float 46 has a bow 22 and a stern 23 and is mounted on the shaft 21 at the side of the stern 23 by one or more arms 26 (two arms in the example illustrated, flanking the float 46 in the manner of cheeks).

As may be seen clearly in FIG. 17, each float 46 has, in longitudinal section, a shape that is profiled in order to offer a low coefficient of drag and therefore put up only a small amount of frontal resistance to the waves. In the example illustrated, the float 46 has an elliptical profile. The float(s) 46 is (are) free to rotate with respect to the secondary float(s) 19 and is (are) coupled to a converter 34 in the way described hereinabove.

This (these) float(s) 46 improve the output of the plant 1 by contributing to the production of electrical energy. Given its (their) orientation, the opposite to that of the floats 18, 19, the float(s) 46 oscillates (oscillate) in the opposite direction to these and therefore afford a contrarotating effect which has a tendency to stabilize the platform 2.

According to another alternative form illustrated in FIG. 18, the primary shaft 20 and the secondary shaft 21 are coaxial, the secondary shaft 21 extending as a projection from a side wall 5. In the example illustrated, in which the machine 3 has multiple secondary floats 21 situated on each side of the lane 6, the shaft 21 comprises two coaxial portions extending one on each side of the casings 4. The primary floats 18 and the secondary floats 19 do not, however, extend the same distance away from their shaft 20, 21, so that the offset D1 between them remains. In practice, this offset may be afforded by a difference in length of the arms 26. Because the oscillations of the primary floats 18 and of the secondary floats 19 are not synchronous, it will be appreciated that the floats 18, 19 are not connected in terms of rotation and separately drive dedicated converters 34.

1. A wave energy plant which comprises:
a semisubmersible platform provided with at least one longitudinal casing which extends from a bow to a stern of the platform;
a wave energy machine mounted on the platform, this machine comprising:
a gantry mounted transversely on the casing at the bow of the platform,
floats arranged in such a way as to allow the wave energy to be converted into mechanical energy, each float comprising a bow facing towards the bow of the platform and a stern facing towards the stern of the platform, each float being mounted with the ability to rotate with respect to the gantry on a shaft secured thereto, situated on the side of the bow of the float, and
a converter,
wherein:
the wave energy machine comprises at least one primary float and one secondary float which is offset from the primary float towards the bow of the platform; and
the platform comprises at least one stabilizing fin extending transversely short of the lower edges of the casings of the platform.

2. The wave energy plant as claimed in claim 1, wherein the primary float is mounted with the ability to rotate with respect to the gantry on a primary shaft secured thereto, and the secondary float is mounted with the ability to rotate with respect to the gantry on a secondary shaft secured thereto and offset longitudinally with respect to the primary shaft towards the bow of the platform.

3. The wave energy plant according to claim 1, wherein the platform comprises at least two longitudinal casings delimiting a central lane in which at least one primary float is positioned, and in that the gantry is mounted transversely between the casings and in that at least one secondary float is mounted outside the central lane.

4. The wave energy plant as claimed in claim 3, wherein the wave energy machine comprises at least two secondary floats positioned one on each side of the central lane.

5. The wave energy plant as claimed in claim 1, wherein the platform at its stern comprises a transverse buoyancy beam secured to the casing.

6. The wave energy plant as claimed in claim 1, wherein each float comprises a bottom and side walls, is mounted with the ability to rotate with respect to the gantry about a position of equilibrium corresponding to a water line of the float, and in that the float is provided with a pair of fins which project from the side walls near its stern, each fin having an intrados that is inclined, with respect to the water line, downwards towards its stern.

7. The wave energy plant as claimed in claim 1, wherein the converter comprises at least one ratchet wheel.

8. The wave energy plant as claimed in claim 1, wherein the converter comprises a main gearwheel secured to the shaft in direct mesh with a ratchet wheel.

9. The wave energy plant as claimed in claim 8, wherein the converter comprises a secondary gearwheel secured to the shaft in mesh with a ratchet wheel via a reversing pinion.

10. The wave energy plant as claimed in claim 1, wherein the converter comprises at least one flywheel.

11. The wave energy plant as claimed in claim 1, wherein the wave energy machine comprises at least one additional float, mounted with the ability to rotate with respect to the gantry on the shaft, on the side of the stern of the additional float.
